(19) United States
(12) Patent Application Publication
(10) Pub. No.: US 2026/0311038 A1
(43) Pub. Date: Oct. 8, 2026

(54) OrinAI (Human-Centered Agent Creation and Deployment Platform)

(71) Applicant: Anthony Shawn Boyd, Valencia, CA (US)

(72) Inventor: Anthony Shawn Boyd, Valencia, CA (US)

(21) Appl. No.: 19/171,148

(22) Filed: Apr. 4, 2025

(51) Int. Cl. G06N 20/00

(52) U.S. Cl. CPC G06N 20/00

(57) ABSTRACT

The invention relates to a human-centered AI agent creation and deployment system that enables users to build, train, personalize, and deploy artificial intelligence agents through a no-code or low-code interface. The platform supports both technical and non-technical users by providing guided onboarding, context-aware tools, and relational agent templates, Agents are capable of performing autonomous tasks with the user's active input and permission, learning from user interactions, and adapting to workflows across education, professional, and creative sectors. Users can monitor, refine, and iterate agents over time through a dynamic dashboard. The system includes modular architecture supporting voice, text, and visual modalities, and features a secure compliance layer for ethical deployment. It also supports monetization through a controlled marketplace. The system supports agentic reasoning, persistent memory, and scalable deployment. It enables integration with multimodal systems, reflective feedback, agentic RAG optimization, and real-time voice interaction for secure, collaborative, and ethical AI use.

### 1. FIELD OF THE INVENTION

This invention relates to artificial intelligence (AI) agent creation, management, and deployment systems that allow users to generate, organize, and utilize AI agents efficiently through a user-friendly platform. It utilizes customizable, context-aware, and ethically aligned AI agents. The invention encompasses support for both agentic AI systems, which can learn and act with autonomy, and physical AI applications, such as robotic systems, IoT devices, and other real-world integrations.

### 2. BACKGROUND OF THE INVENTION

Currently, AI systems often require complex development processes, making it difficult for individuals or businesses to create AI agents that meet their specific needs without significant technical knowledge. This invention simplifies that process by offering a guided, interactive experience that empowers users of all skill levels to create and deploy AI agents seamlessly. With the rise of agentic AI and its adoption across industries, there is a growing demand for platforms like OrinAI that prioritize accessibility, ethical safeguards, and compatibility with industry-specific systems.

### 3. SUMMARY OF THE INVENTION

This invention provides a streamlined process for creating, managing, and deploying AI agents using text-based and voice-guided prompting. It features an intuitive UI/UX, gamified elements to encourage engagement, and a high-level security system to protect user data and AI-generated content. Additionally, the invention introduces an open, modular marketplace for AI agents and LLMs, designed for interoperability with other platforms and grounded in NIST-aligned ethical compliance standards. The invention also introduces an open, modular marketplace for AI agents and LLMs, designed for interoperability with other platforms and grounded in NIST-aligned ethical compliance.

### 4. DETAILED DESCRIPTION

The OrinAI platform comprises the following core systems:
Drag-and-Drop AI Agent Builder: Enables intuitive creation of AI agents via guided, visual workflows. Supports all user skill levels through voice/text prompting and real-time feedback mechanisms.
Cross-Platform Marketplace: A secure, interoperable marketplace for sharing, selling, and monetizing AI agents and LLMs—including third-party integrations. Built with ethical AI safeguards, including a certification system that ensures all listed agents comply with NIST AI RMF safety standards.
Plug-and-Play Integration System: Allows agents created on OrinAI to interface with or extend the functionality of third-party systems across industries. Supports export of agents with secured licensing.
Agent Validation Services: Validates agents from external sources to ensure conformity with platform safety, ethics, and interoperability requirements prior to marketplace listing.
Performance Analytics: Continuously optimizes agent effectiveness via behavior tracking and adaptive learning.
Cloud & On-Device Deployment: Supports AWS for scalability with future extensions for Azure and Nvidia. Designed for edge deployment scenarios.
Human-AI Co-Creation Interface: Prioritizes respectful collaboration between users and agents, Designed to empower users with dynamic feedback loops, education, and agency, not replacement.
Multi-Platform Support: Ensures usability across mobile, desktop, and browser-based applications.
Ethical AI Safeguards: To ensure responsible AI usage and prevent the creation of agents that may harm humanity. The environment, or economic structures. Autonomous agents must receive human approval before taking major actions and are guided by transparent ethical rules embedded in the OrinAI architecture

### 6. Conclusion

OrinAI is a next-generation AI agent development platform that empowers users to create ethical, intelligent, and adaptable agents and LLMs across various domains. By offering an intuitive drag-and-drop interface, built-in governance protocols, and guided agent creation workflows, OrinAI removes technical barriers for non-experts while providing the depth and control advanced users expect. Through features such as secure cloud and on-device deployment, NIST-aligned ethical guardrails, and a cross-platform agent marketplace, OrinAI fosters responsible innovation and accessibility. Its co-creation interface promotes human-AI collaboration built on trust, transparency, and continuous user feedback loops. Designed to scale across industries, OrinAI enables individuals and organizations to build, deploy, and monetize agents with confidence, making ethical AI both usable and profitable for everyone.

### 7. DRAWINGS & FIGURES

The invention includes three illustrative Figures-FIG. 1. FIG. 2, FIG. 3, that represent key user interaction points and system design features. These figures clarify previously disclosed concepts and do not introduce new subject matter. The replacement drawing sheets for FIG. 1 through FIG. 3 have been submitted separately in compliance with 37 CFR 1.84 and 1.121(d), accompanied by a transmittal document. References to these figures remain consistent with the original disclosure.

FIG. 1: Landing UI—Introduces the platform with a clear call to action and core values. It depicts the initial interface users encounter upon visiting the OrinAI platform. This interface features a structured layout highlighting OrinAI's value propositions, such as “human-centered,” “practical,” and “easy to use.” The figure includes call-to-action buttons such as “Create Agent,” navigation menus, and visual cues emphasizing trust and accessibility,

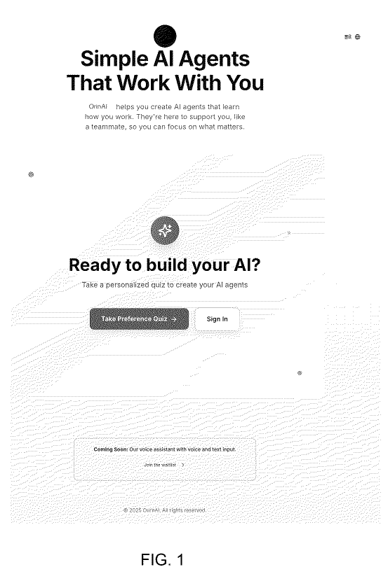

FIG. 2: Dashboard—displays templates and user agents with descriptions and quick start buttons. Users can choose to modify ex agents or pre-built template tailored to specific use cases. The figure illustrates the user's agent workspace. This includes multiple agent templates, previously built agents, and actionable buttons for “Edit,” “Deploy,” and “Duplicate.” A sidebar provides categorized agent types by use case (e.g., customer service, education, legal). Tooltips and real-time assistance features are also shown, helping users quickly navigate the dashboard and build from existing templates.

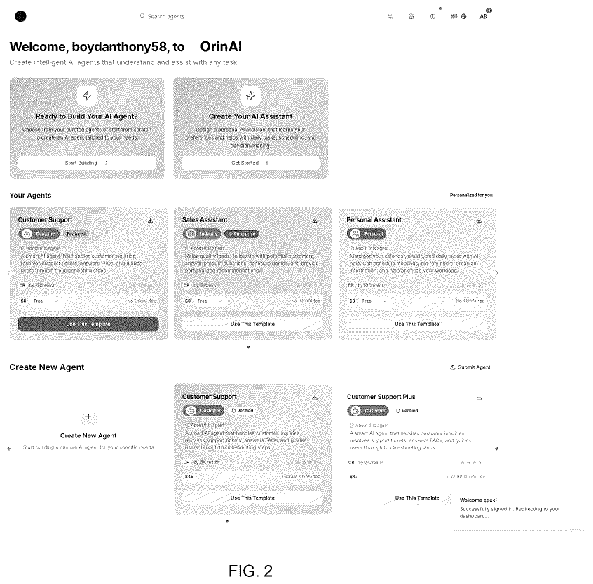

FIG. 3: Agent Setup Step 1—Captures the first step in agent creation. This screen initiates a guided flow, showing the first screen in the agent creation process, which helps users progress through setup with minimal technical input. Users are prompted to input the agent's name, define its core purpose, and optionally tag the use case domain. The figure highlights guided tooltips, progress indicators (e.g., Step 1 of 4), and input validations to ensure smooth and structured configuration. The UI emphasizes low technical barriers and clear user control throughout the process.

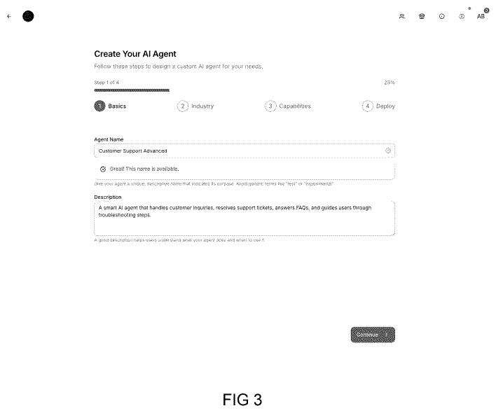

1. A system for personalized AI interaction comprising a naming module that enables user-defined assistant nicknames, with safeguards against offensive or malicious inputs, Including a voice customization system that allows both selection of preset voice profiles and user voice cloning, with consent verification and secure encryption.

2. A marketplace system for distributing, customizing, and monetizing AI agents and LLMs across industries, with support for cross-platform integration and API interoperability.

3. A growth mode toggle that adapts assistant behavior and tone based on user developmental stage, with controlled parental access for minors.

4. A legacy transfer system for packaging and transferring user-trained AI agents, workflows, and assistant identities to designated recipients.

5. A dashboard interface for managing nickname, voice, memory, agent updates, and transfer permissions.

6. A modular framework enabling the creation and deployment of relational agentic AI systems that learn, adapt, and collaborate with users while adhering to human-in-the-loop guidance.
